(19) United States
(12) Patent Application Publication
(10) Pub. No.: US 2016/0236103 A1
(43) Pub. Date: Aug. 18, 2016

(54) STUFFED TOY FOR HOLDING INFANT ITEMS

(71) Applicant: Jackson Evans Pettrey, III, Stuarts Draft, VA (US)

(72) Inventor: Jackson Evans Pettrey, III, Stuarts Draft, VA (US)

(21) Appl. No.: 14/967,506

(22) Filed: Dec. 14, 2015

Related U.S. Application Data
(60) Provisional application No. 62/116,971, filed on Feb. 17, 2015.

(51) Int. Cl. A63H 3/00; A61J 17/00; A63H 3/02

(52) U.S. Cl. CPC A63H 3/003; A63H 3/02; A61J 17/007

(57) ABSTRACT

Disclosed is a stuffed toy which includes a body of the stuffed toy and at least one fastener. The body includes a cavity to store one or more infant items. The fastener is attached to the body of the stuffed toy to fasten the one or more infant items with the body of the stuffed toy.

### CROSS-REFERENCE TO RELATED APPLICATION

The present application is related to provisional patent application Ser. No. 62/116,971, filed on Feb. 17, 2015, and titled “STUFFED ANIMAL TOY WITH CHARACTERISTIC OF HOLDING INFANT ITEMS”. The entire disclosure of the above patent application is hereby incorporated by reference.

### FIELD OF THE INVENTION

This invention relates to toys and more particularly to stuffed toys for holding infant items.

### BACKGROUND

Infants often play with and use various infant items and other infant play simulation items that occupy their attention, namely pacifiers, rattles, teethers. These items are designed for infants to view, grasp, hold in their hands, and possibly even put into their mouth.

A problem occurs when the infant or baby is unable to hold these items in its hand and drops down the items and it moves out of its view and/or out of its reach. On one hand, losing these items becomes problematic for the infant who often becomes upset and begins crying. On the other hand, this is also problematic for parents who do not want their infant to become upset and cry. It is much more problematic for the parents when they are busy and unable to continually retrieve the item for their infants.

In the past, small mechanical devices have been developed that attaches various infant items such as pacifiers to it. However, these devices are not that effective and attention seeker for the infants and thereby fail to keep the infant items within the infant's reach. Such devices are often developed with the intention to prevent losing of the item, but not as the device to attract the infants' attention.

Traditionally, stuffed animals are known form of toys. These stuffed animals give pleasure and enjoyment to children. Children derive a sense of comfort and companionship in addition to just playing with them because of their push composition and typical appealing design. However existed stuffed animals, dolls and/or other similar objects are limited by their application to just provide comfort and appealing look. These existing stuffed animals has just remained as a toy after all and none of them are found addressing problem of infants and their parents discussed above.

Therefore, in view of the foregoing, applicant has invented a new and improved stuffed toy, namely a stuffed animal with a characteristic of holding infant items, namely pacifiers and/or other infant play simulation items.

### SUMMARY

It will be understood that this disclosure in not limited to the particular systems, design and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an object of the present invention to provide a stuffed toy, such as a stuffed animal having a characteristic to hold one or more infant items and other infant play-stimulation items.

It is an object of the present disclosure to provide a new and useful stuffed toy.

It is another object of the present disclosure to provide a solution to above discussed problem in the background art that enables parents to fasten or release one or more infant items such as pacifiers to and from the stuffed animals loved by their children.

It is another object of the present invention to enable the infants to get rid off of infant items such as pacifiers later in life when they're ready to get rid of them or no longer need pacifier feeding without having to discard or put aside their familiar stuffed animal.

In an embodiment, there is provided a stuffed toy which includes a body of the stuffed toy and at least one fastener. The body includes a cavity to store one or more infant items. The fastener is attached to the body of the stuffed toy to fasten the one or more infant items with the body of the stuffed toy.

The body includes a head portion, a pair of arms, and a pair of legs. The fastener is attached to at least one of the pair of arms and the pair of legs.

The infant items comprise one or more pacifier.

The cavity is made on a back of the body.

The cavity comprises a zipper to close the cavity for securing the one or more infant items in the cavity.

The foregoing has outlined rather broadly the features and technical advantages of the present disclosure in order that the detailed description of the disclosure that follows may be better understood. Additional features, and advantages of the disclosure will be described hereinafter which form the subject of the claims of the disclosure. It should be appreciated that the conception and specific embodiment disclosed may be readily utilized as a basis for modifying or designing other structures for carrying out the same purposes of the present disclosure. It should also be realized that such equivalent constructions do not depart from the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 illustrates a stuffed toy storing one or more infant items and other infant play simulation items, according to one embodiment.

FIG. 2 illustrates a stuffed toy with one or more infant items fitted to a body of the stuffed toy, according to one embodiment.

FIG. 3 illustrates a stuffed toy with one or more infant items fitted to a body of the stuffed toy, according to another embodiment.

FIG. 4 illustrates a stuffed toy with fastener means in open position, according to an exemplary embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Stuffed toys, such as stuffed animal toys, are made with an outer skin material completely filled to the desired configuration with a stuffing material, usually to an extent where the outer skin becomes relatively taut. Example stuffed toys may be stuffed animal toys, super hero toys, and celebrity toys.

It is to be understood that present embodiment of the invention is independent of the nature, shape and size of the stuffed toys. Though the stuffed animals, namely stuffed bunny and stuffed elephant are described herein as an example. It should be understood that the application of the invention and its utility extends to any stuffed animals, stuffed dolls and/or other geometric shape stuffed objects.

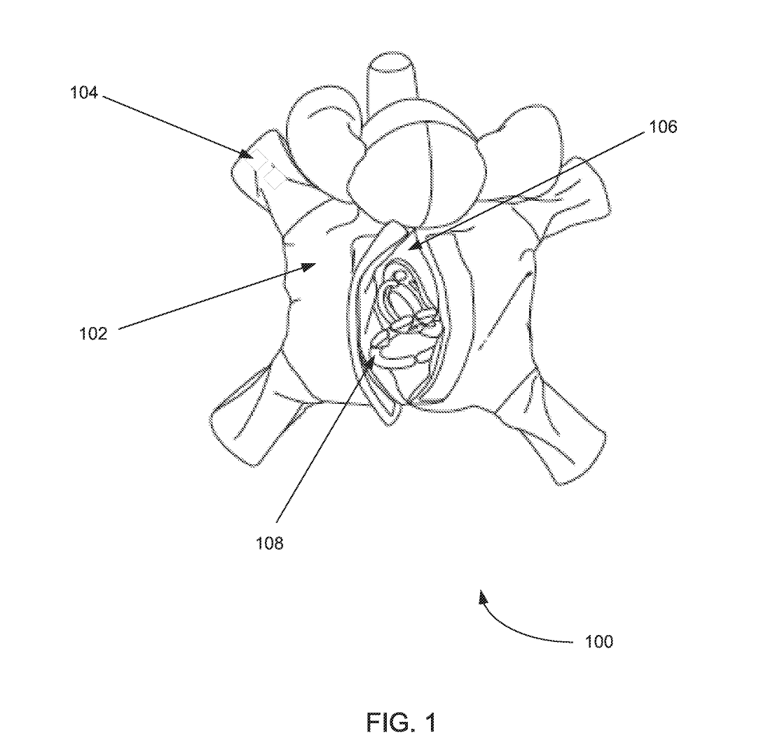

As seen in the accompanying FIG. 1-FIG. 4, the stuffed toy 100 includes a body 102 of the stuffed toy 100 and at least one fastener 104. The body 102 includes a cavity 106 to store one or more infant items 108. The fastener 104 is attached to the body 102 of the stuffed toy 100 to fasten the one or more infant items 108 with the body 102 of the stuffed toy 100.

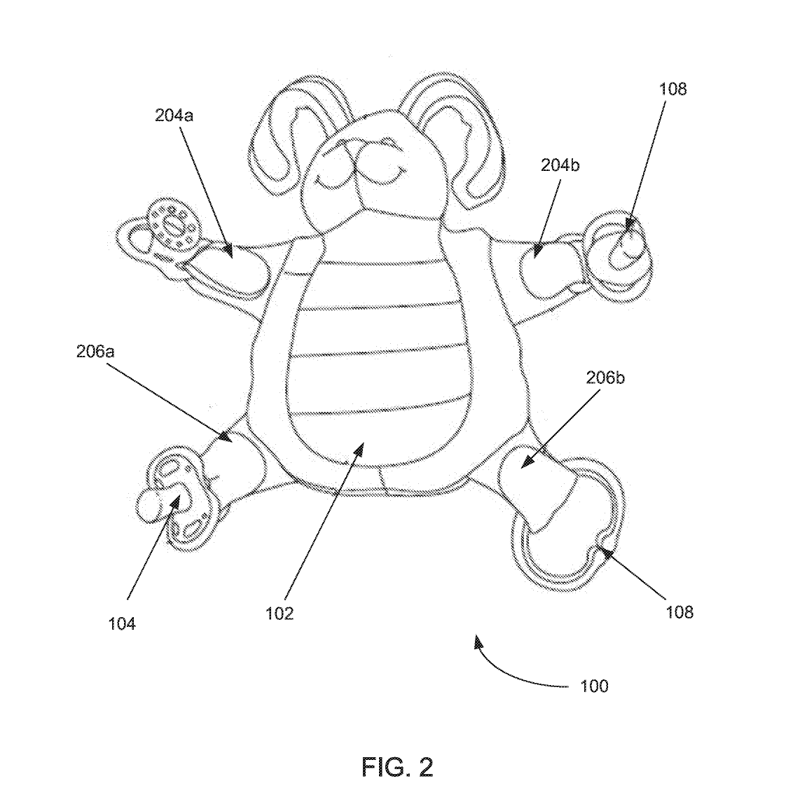

For a better understanding of the objects of the invention, reference should be made to the drawings, here shown as a stuffed bunny 100 in FIG. 1 and a stuffed elephant 100 in FIG. 2, although, of course, other animals or objects may be represented.

FIG. 1 shows the stuffed animal, for example the stuffed bunny 100 and the stuffed elephant 100 in one of their numerous characteristic poses holding various infant items 108 in their flexible and soft arms and legs. The infant items 108 include but not limited to pacifiers, rattles, teethers and the like.

Referring now to FIG. 2 which shows the stuffed toy 100 that includes a head portion 202, a pair of arms 204a and 204b, and a pair of legs 206a and 206b. The fastener 104 is attached to the pair of arms 204a and 204b and/or the pair of legs 206a and 206b.

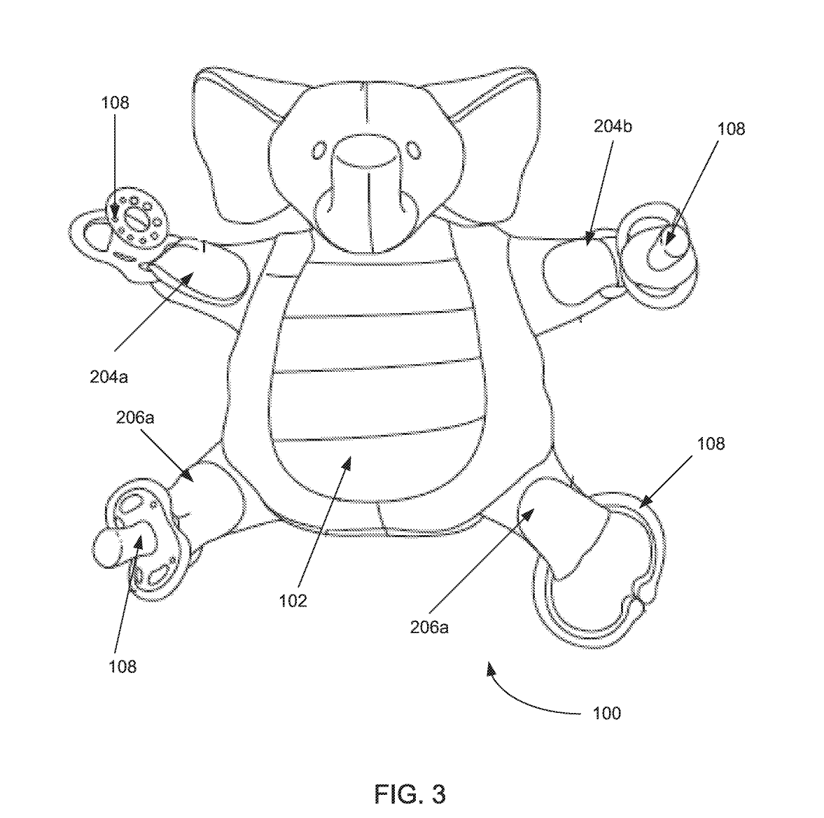

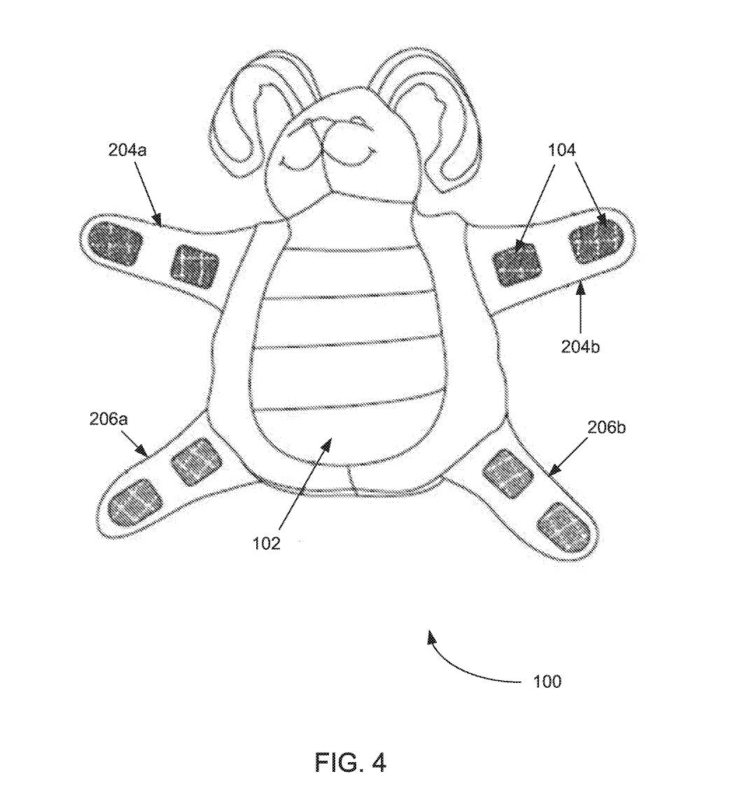

The user of the proposed stuffed toy 100, for example parents are able to engage and disengage their infant items 104 from the stuffed toy 100 by manipulating the fastener 104 configured on the pair of legs 206a, 206b and arms 204a, 204b of the stuffed toy 100. As seen in FIG. 4, each of the arms 204a, 204b and the legs 206a, 206b is provided with the fastener 104. Though the fastener 104, a Velcro® fastener is shown configured along the arms 204a, 204b and the legs 206a, 206b of the stuffed toy 100 in one embodiment, it should be understood that any other suitable fastener can be used. The fastener 104 in its open state (as shown in FIG. 4) relaxes the arms 204a, 204b and the legs 206a, 206b of the stuffed toy 100 and therefore enables the parents to place and fasten the infant items 108 to the stuffed toy 100. When the infant items 108 are placed within the realm of the fastener 104, the fastener 104 is closed to securely hold the infant items 104 to the legs 206a, 206b and/or the arms 204a, 204b of the stuffed animal 100 (as shown in FIG. 2 and FIG. 3).

The infant items 104 can be replaced easily because different types of infant items 104 are stored in the cavity 106 of the stuffed toy 100. The infants can have view of their favorite infant items 104 when they are playing with the stuffed animal 100. Also, the infants can hold the infant items 104 in their hand and can put them in their mouth while playing with the stuffed animal toy 100. As the fastener 104 facilitate detaching of the infant items 104 from the body 102 of the stuffed, therefore, also helps the infants to get rid off of the infant items 104 as the infants grow. Even the infant items 104 can be put in the cavity 106 of the stuffed toy 100 when there is no need of the infant items 104 by the infant.

Although stuffed animal toys have been depicted in the exemplary embodiment discussed above, other stuffed toys in the form of dolls or any other geometrical shaped object can be contemplated.

It will finally be understood that the disclosed embodiments are presently preferred examples of how to make and use the claimed disclosure, and are intended to be explanatory rather than limiting of the scope of the disclosure as defined by the claims below. Reasonable variations and modifications of the illustrated examples in the foregoing written specification and drawings are possible without departing from the scope of the disclosure as defined in the claim below. It should further be understood that to the extent the term “disclosure” is used in the written specification, it is not to be construed as a limited term as to number of claimed or disclosed disclosures or the scope of any such disclosure, but as a term which has long been conveniently and widely used to describe new and useful improvements in technology The scope of the disclosure supported by the above disclosure should accordingly be construed within the scope of what it teaches and suggests to those skilled in the art, and within the scope of any claims that the above disclosure supports. The scope of the disclosure is accordingly defined by the following claims.

1. A stuffed toy comprising:
a body of the stuffed toy having a cavity to store one or more infant items; and
at least one fastener attached to the body of the stuffed toy to fasten the one or more infant items with the body of the stuffed toy.

2. The stuffed toy of claim 1, wherein the body comprising:
a head portion;
a pair of arms; and
a pair of legs, wherein the at least one fastener is attached to at least one of the pair of arms and the pair of legs.

3. The stuffed toy of claim 1, wherein the one or more infant items comprise one or more pacifier.

4. The stuffed toy of claim 1, wherein the cavity is made on a back of the body.

5. The stuffed toy of claim 4, wherein the cavity comprises a zipper to close the cavity for securing the one or more infant items in the cavity.
